(19) United States
(12) Patent Application Publication
(10) Pub. No.: US 2013/0118426 A1
(43) Pub. Date: May 16, 2013

(54) Method for Operating an Internal Combustion Engine and an Internal Combustion Engine

(71) Applicant: Peter Kreuter, Aachen (DE)

(72) Inventor: Peter Kreuter, Aachen (DE)

(73) Assignee: META MOTOREN- UND ENERGIE-TECHNIK GMBH, Herzogenrath (DE)

(21) Appl. No.: 13/811,545

(22) PCT Filed: Jul. 8, 2011
(86) PCT No.: PCT/EP2011/003417

§ 371 Date: Jan. 22, 2013

(30) Foreign Application Priority Data
Jul. 23, 2010 (DE) 10 2010 032 055.2

(51) Int. Cl. F02F 3/00

(52) U.S. Cl. CPC F02F 3/00
USPC 123/90.1; 123/193.4

(57) ABSTRACT

An internal combustion engine includes a power cylinder having a power chamber delimited by a power piston, the power chamber having an intake valve and an exhaust valve, a compression cylinder having a compression chamber delimited by a compression piston, the compression chamber having a fresh charge intake valve, and a flow-through chamber delimited by a flow-through piston and fluidly connected with the compression chamber via a flow-through passage. The flow-through chamber is directly or indirectly connected with the power chamber via a push-out passage. A flow-through valve is disposed in the flow-through passage. A cooler is arranged so as to cool compressed fresh charge flowing through the first flow-through passage. The pistons and the valves are movable such that the cooled, compressed fresh charge is pushed over by the compression piston from the compression chamber into the first flow-through chamber and is ultimately pushed out into the power chamber.

The invention relates to a method for operating an internal combustion engine and to an internal combustion engine that operates in accordance with such a method.

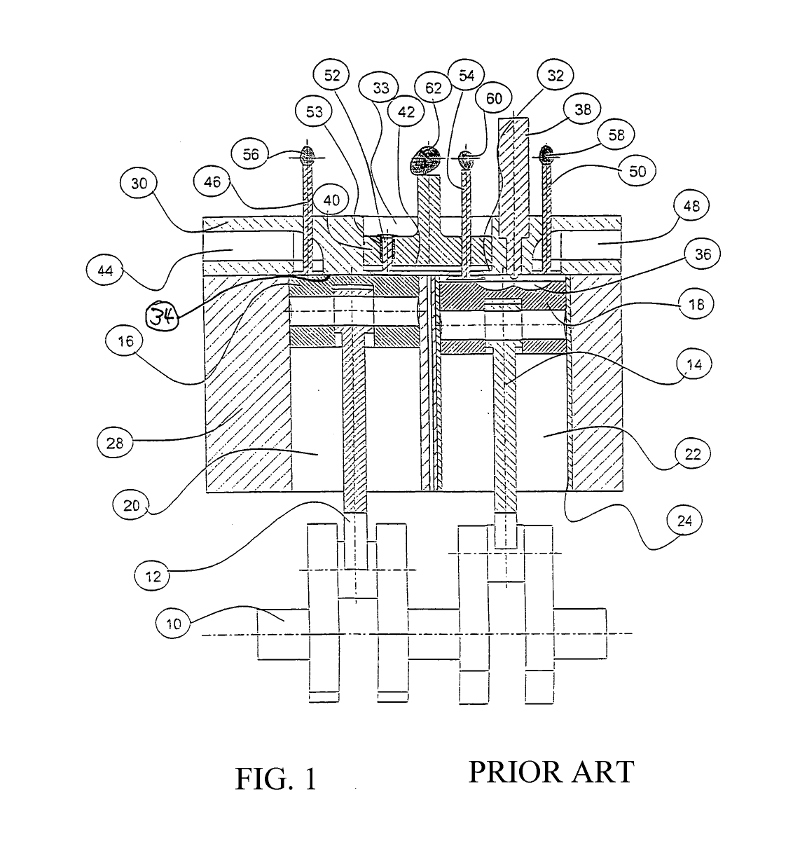

The independent patent claims emanate from WO2009/083182. In this publication an internal combustion engine is described, which is illustrated in FIG. 1 that is taken from above-the mentioned document; the internal combustion engine includes a crankshaft 10 having two adjacent cranks that are each connected via a piston connecting rod 12 and 14, respectively, with a compression piston 16 and a power piston 18, respectively. The compression piston 16 is movable within a compression cylinder 20. The power piston is movable within a power cylinder 22, wherein the power cylinder 22 is preferably lined with a cylinder liner 24.

The cylinders, which are preferably formed within a common cylinder housing 28, are sealed from above by a cylinder head 30, which includes an end wall 32 in an area overlapping the two cylinders 20 and 22; the end wall 32 encloses portions of the cylinders 20 and 22 from above and encloses a flow-through cylinder 33 formed in the cylinder head 30 from below.

A compression chamber 34, not labeled in FIG. 1, is formed between the compression piston 16 and the cylinder head 30; the volume of the compression chamber is at least nearly zero in the top dead point position of the compression piston 16, which top dead point position is illustrated in FIG. 1. A power chamber 36 is formed between the power piston 18 and the cylinder head 30; an injection valve 38 projects into the power chamber 36.

A flow-through piston 40 is movable in the flow-through cylinder 33; the flow-through piston 40 delimits a flow-through chamber 42.

A fresh air and/or fresh charge intake manifold 44 is formed in the cylinder head 30; a fresh charge intake valve 46 operates in the manifold 44 and controls the connection between the fresh charge intake manifold 44 and the compression chamber 34. The term “fresh charge” comprises the substances “pure fresh air” and “fresh air with fuel and/or residual gas added into it”.

An exhaust manifold 48 is also formed in the cylinder head 30; an exhaust valve 50 operates in the exhaust manifold 48 and controls the connection between the power chamber 36 and the exhaust manifold 48.

A flow-through opening, which connects the compression chamber 34 with the flow-through chamber 42, is formed in the end wall 32; a flow-through valve 52 operates in the flow-through opening and opens when moved away from the compression chamber. A shaft of the flow-through valve 52 is movably guided in the flow-through piston 40 in a sealed manner, wherein the flow-through valve 52 is movable into the flow-through piston 40 against the force of a spring 53 and is movable out of the flow-through piston 40 preferably with a restricted stroke.

An intake valve 54 operates in another opening of the end wall 32, which opening connects the flow-through chamber 42 with the power chamber 36; the shaft of the intake valve 54 is movably guided through the flow-through piston 40 in a sealed manner.

A fresh charge intake cam 56, an exhaust cam 58 and an intake cam 60 serve to actuate the valves 46, 50, 54, respectively. The flow-through piston 40 is actuated by a flow-through cam 62.

The cams are formed in an appropriate manner on one or more cam shafts that are preferably driven by the crankshaft 10 at the same rotational speed as the rotational speed of the crankshaft.

The function of the internal combustion engine is explained in detail in the above-mentioned WO2009/083182. The essential advantage, which is achieved with the described internal combustion engine relative to conventional internal combustions engines, is that the fresh charge is compressed by the compression piston 16 in the compression cylinder 20 outside the hot power cylinder 22 and pushed over into the flow-through chamber 42, where it is first further compressed by the flow-through piston 40 and then pushed through the open intake valve 54 into the power chamber 36, and is combusted there, after or during the supply of fuel by the fuel injection valve 38. Alternatively or additionally, fuel can be added to the fresh charge already upstream from the intake valve 54 in the fresh charge intake manifold 44 or in the compression chamber 34 or in the flow-through chamber 42, so that the combustible mixture is “injected” through the open intake valve 54 into the power chamber 36 and combusted there while undergoing spark ignition or self-ignition. The compression of the fresh charge outside the power chamber improves the efficiency of the internal combustion engine. The addition of fuel to the fresh charge upstream from the intake valve 54 leads to an excellent mixture preparation, which in turn is a prerequisite for a complete and substantially pollution-free combustion.

For certain fuels, if they are added to the fresh charge upstream from the intake valve 54, the risk exists of a self-ignition already in the flow-through chamber due to the high final compression temperature occurring there.

An internal combustion engine having external multi-stage compression is described in CH 96 539 A. In a compression cylinder, fresh air is compressed in a compression chamber by a compression piston formed in one-piece with a flow-through piston, and is pushed over through a flow-through valve, which is formed as a simple check valve, into a cooled buffer chamber inside a cooler; the cooled, compressed fresh charge from the cooler arrives in a flow-through chamber through a further check valve during a downward movement of the flow-through piston, which is fixedly connected with the compression piston, wherein the maximum volumes of the compression chamber and of the flow-through chamber are approximately equal, and the size of the buffer volume is similar to the maximum volume of the flow-through chamber. During an upstroke of the flow-through piston, the fresh air is pushed over by an intake valve of the power cylinder from the flow-through chamber into the power chamber through a further check valve, which borders the flow-through chamber, and a line 10.

An internal combustion engine having an external two-stage piston compressor and a power cylinder is described in DE 24 10 948. A cooler is provided between the exhaust valve of the first compression stage and the intake valve of the second compression stage, which forms a buffer volume for the fresh air compressed in the first compression stage. The fresh air compressed in the second compression stage is guided through an exhaust gas heat exchanger, in which the compressed fresh air is heated by the exhaust gas flowing out of the power cylinder and subsequently arrives in the power cylinder through an intake valve.

U.S. Pat. No. 4,299,090 describes a piston internal combustion engine having two exhaust gas turbochargers, which both supply the internal combustion engine with fresh air at high exhaust gas flows and/or at high load. At only a low load and small exhaust gas flow, one of the exhaust gas turbochargers is switched off to increase the charging pressure.

An internal combustion engine with an exhaust gas turbocharger is described in the article by Kramer, W.; Indirekte Ladeluftkühlung bei Diesel- and Ottomotoren, MTZ, 02/2006, pp. 104-109, in which the charging air compressed in the exhaust gas turbocharger flows through and then is guided to the intake of the internal combustion engine.

The object underlying the invention is to further develop the above-described method and the above-described internal combustion engine in such a way that the risk of a self-ignition of the mixture upstream of the intake valve 54 is reduced.

The part of the object of the invention relating to the method is achieved with the features of claim 1.

Dependent claims 2 and 3 are directed to advantageous embodiments of the inventive method.

The part of the object of the invention relating to the internal combustion engine is achieved with the features of claim 4.

Claims 5 to 10 are directed to advantageous embodiments of the inventive internal combustion engine.

The invention will be explained in an exemplary manner in the following with the assistance of schematic drawings and with further details.

In the Figures:

FIG. 1 shows a schematic sectional view of an already-explained, known internal combustion engine,

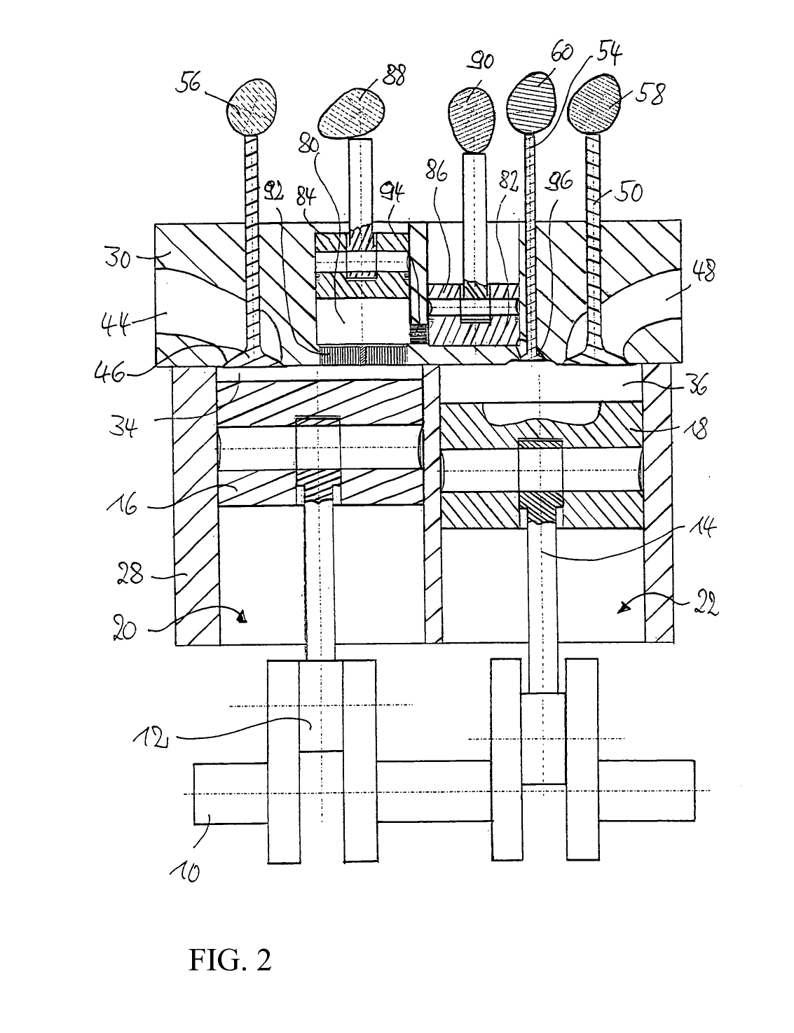

FIG. 2 shows a corresponding view of an inventive internal combustion engine,

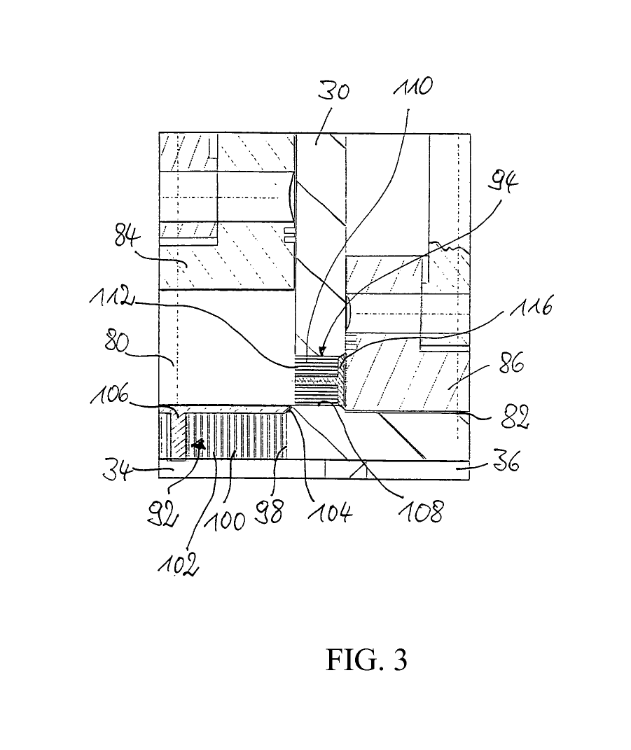

FIG. 3 shows a detail view of FIG. 2 and

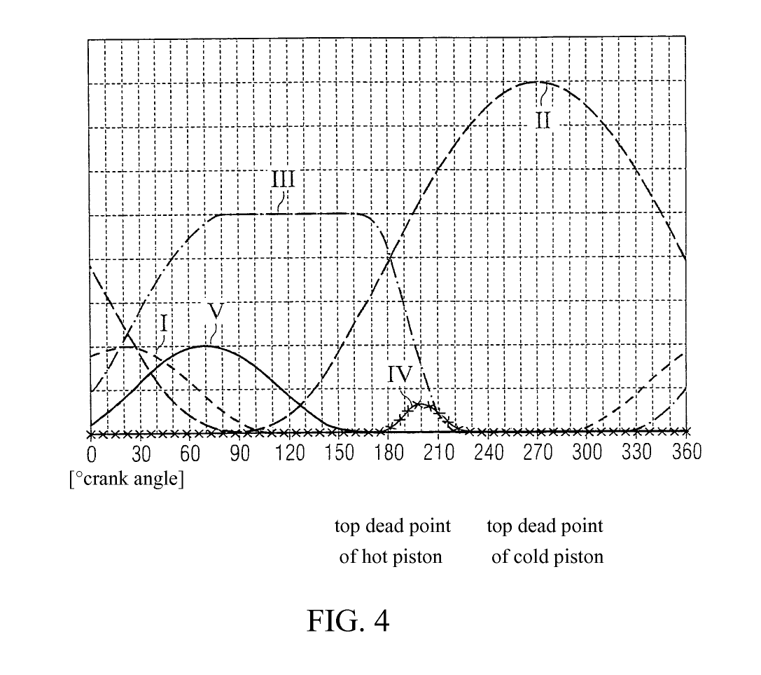

FIG. 4 shows control timing diagrams relating to the internal combustion engine according to FIG. 2.

The internal combustion engine according to FIG. 2 corresponds in large portions to that of FIG. 1. Corresponding parts are assigned the same reference numbers as in FIG. 1, so that only the differences to the internal combustion engine according to FIG. 1 are explained in the following.

A substantial difference between the internal combustion engine according to FIG. 1 and FIG. 2 is that, in the embodiment according to FIG. 2, two flow-through chambers 80 and 82 are disposed in the cylinder head 30, in each of which a flow-through piston 84 and 86 operates, which is moved by its own flow-through cam 88 and 90, respectively. The flow-through chamber 84 is connected with the compression chamber 34 via a flow-through passage 92. The flow-through chamber 82 is connected with the flow-through chamber 80 via a flow-through passage 94. A push-out passage 96, in which the intake valve 54 operates, leads from the flow-through chamber 82 into the power chamber 36.

The flow-through chambers 80, 82, flow-through pistons 84, 86, flow-through passages 92, 94, as well as the push-out passage 96 and the valves disposed in the passages form a flow-through apparatus. The structure of the flow-through passages 92 and 94 will be explained in more detail with the assistance of FIG. 3.

The flow-through passage 92 is formed by a through-opening 98, which leads through a wall of the cylinder head 30 and connects the compression chamber 34 with the flow-through chamber 80. A cooler 100 is utilized in the through-opening 98; heat exchanger channels 102 of the cooler 100 form the actual fluid passage between the compression chamber 34 and the flow-through chamber 80. The edge of the through-opening 98 facing the flow-through chamber 80 forms a valve seat 104 for the valve plate of a check valve 106; the check valve 106 opens against the force of a not-illustrated closing spring when the pressure in the flow-through chamber 80 is less than in the compression chamber 34.

The flow-through passage 94 is similar to the flow-through passage 92 in its basic structure, and has a through-opening 108 in a wall of the cylinder head 30, which wall separates the flow-through chambers 80 and 82. A cooler 110 is utilized in the through-opening 108; heat exchanger channels 112 of the cooler 110 form the fluid passage between the flow-through chambers. The edge of the through-opening 108 facing towards the flow-through chamber 82 forms a valve seat for the plate of a check valve 116; the check valve 116 opens against the force of a not-illustrated closing spring when the pressure in the flow-through chamber 82 is lower than the pressure in the flow-through chamber 80.

The not-illustrated closing springs associated with the check valves 106 and 116 are known with regard to their structure and their arrangement, and can for example be coil springs surrounding the shaft of the respective valve member, which coil springs are integrated into the cooler and are supported between the cooler and a collar of the shaft. The closing springs are designed such that the biasing force, with which the respective valve member is urged against its seat, is relatively small, so that even a small pressure differential acting on the closed valve member in its opening direction leads to a valve-opening.

The construction of the flow-through passage 92 is advantageously such that the minimum volume of the compression chamber in the top dead point of the compression piston 16 is small; advantageously it is less than 15%, even more advantageously less than 1%, of the maximum volume of the compression chamber in the bottom dead point of the compression piston.

In the closed state of the check valve 106, the upper side of the valve member of the check valve 106 is flush with an edge region of the base of the flow-through chamber 80, which edge region optionally surrounds the base of the flow-through chamber 80, so that the flow-through piston 84 in its bottom dead point (in FIG. 2 the flow-through piston 84 is located near its top dead point) moves up directly on the valve member, and the residual volume of the flow-through chamber 80 in the bottom dead point of the flow-through piston 84, which is given by an optionally-present tolerance gap between the flow-through piston 84 and the valve member as well as the volume of the heat exchanging channels 112, is less than 15%, advantageously less than 1%, of the maximum volume of the flow-through chamber 80. As is evident from FIG. 2, the flow-through piston 84 is constructed such that, in its bottom dead point, the piston ring or rings are located directly above the flow-through passage 94 and do not traverse the cooler 110.

The valve member of the check valve 116 is formed such that, in the closed state, it extends flush with the inner wall of the flow-through chamber 82, so that practically no residual volume is present here. The piston ring or rings of the flow-through piston 86 are disposed such that they do not traverse the check valve 116. In the top dead point of the flow-through piston 86 (the position of the flow-through piston 86 illustrated in FIGS. 2 and 3), the volume of the flow-through chamber 82 is advantageously less than 15%, even more advantageously less than 1%, of the maximum volume of the flow-through chamber 82. This is achieved in particular by a suitable construction of the push-out passage 96.

The illustration of FIG. 2 is schematic. All cams can be disposed on a common cam shaft, which is rotatably driven by the crankshaft 10 and rotates at the same rotational speed as the crankshaft 10.

The function of the internal combustion engine according to FIG. 2 is explained in the following with the assistance of the control timing diagrams according to FIG. 4, wherein the abscissa indicates the position of the crankshaft in degrees (° crank angle). The power piston 18 (hot piston) is located at a crank angle of 180° in its top dead point. The compression piston 16 (cold piston) is located at a crank angle of 270° in its top dead point.

The curves indicate the following:

Curve I (dotted): Stroke of the fresh air intake valve 46

Curve II (dashed): Stroke of the flow-through piston 84 (cold flow-through piston); stroke corresponds to the volume of the flow-through chamber 80;

Curve III (dash-dotted): Stroke of the flow-through piston 86 (hot flow-through piston); stroke corresponds to the volume of the flow-through chamber 82;

Curve IV (crosses): Stroke of the intake valve 54 (hot flow-through valve);

Curve V (solid): Stroke of the exhaust valve 50.

Assuming that the compression piston 16 (cold piston) is located at a crank angle of 270° in its top dead point, in which the volume of the compression chamber 34 is nearly zero, and with the fresh charge intake valve 46 closed, the entire compressed fresh charge has been pushed over into the flow-through chamber 80 through the flow-through passage 92 while undergoing cooling. The flow-through piston 84 (cold flow-through piston) is located in the top dead point of the compression piston 16 approximately in its maximally raised position according to FIG. 2, in which the volume of the flow-through chamber 80 is maximal.

The flow-through piston 84 begins its downward movement and compresses the fresh charge located in the flow-through chamber 80. At a crank angle of approximately 330°, the flow-through piston 86 (hot flow-through piston) begins its upward movement, so that the fresh charge compressed in the flow-through chamber 80 flows through the flow-through passage 94, while undergoing cooling, over into the increasing-in-volume flow-through chamber 82 (hot flow-through chamber) with the check valve 116 open. At a crank angle of approximately 80°, the flow-through piston 84 has moved into its lowermost position, so that practically the entire compressed fresh charge is in the flow-through chamber 82, whose flow-through piston 86 is in its uppermost position; the flow-through piston 86 remains in the uppermost position from a crank angle of approximately 90° to approximately 160° as a result of an appropriate contouring of the flow-through cam 90. Starting from a crank angle of approximately 160°, the flow-through piston 86 moves with a steep slope to its bottom dead point, wherein at a crank angle of approximately 180° the intake valve 54 (hot flow-through valve) opens and the maximally compressed fresh charge is pushed out through the push-out passage 96 into the power chamber 36. Shortly before a crank angle of 220°, the volume of the flow-through chamber 82 is minimal. Shortly thereafter, the intake valve 54 closes so that, during downward movement of the power piston 18 (hot piston), the compressed fresh charge pushed into the power chamber 36 combusts while generating power. Before the power piston 18 reaches its bottom dead point, at a crank angle of approximately 350° the exhaust valve 50 begins to open, and closes at a crank angle of approximately 100°, so that residual gas remaining in the power chamber 36 is further compressed by power piston 18.

The opening of the fresh charge intake valve 46 already begins at a crank angle of 300° so that, with the upward movement of the compression piston 16, fresh air or fresh charge flows into the compression chamber 34, and the described cycle begins anew.

The exemplarily described control timings can be changed, as long as the basic principle of the described internal combustion engine is maintained, namely pushing over compressed fresh charge from the compression chamber 34 into the flow-through chamber 80 while undergoing cooling during the flow through the flow-through passage 92, pushing-over of the fresh charge located in the flow-through chamber 80 into the flow-through chamber 82 while undergoing cooling in the flow-through passage 94 and pushing-out of the fresh charge located in the flow-through chamber 82 while undergoing further compression through the push-out passage 96, with intake valve 54 open, into the power chamber 36 and/or the combustion chamber.

In particular if fuel is already added to the fresh charge in the fresh charge intake manifold 44 or in the compression chamber 34, it is advantageous if the flow-through piston 86 moves upwards with a steep slope, and the maximally compressed fresh charge, which is held below its self-ignition temperature due to the intermediate coolings through the coolers 100 and 110, is rapidly “injected” into the power chamber 36 and ignited there while undergoing further heating. When using diesel fuel, a complete and soot-free combustion is achieved.

The described engine can also be operated with spark ignition and/or direct injection into the power chamber 36.

Appropriate constructions will be readily apparent to the skilled person for the construction of the flow-through passages 92 and 94 as well as of the push-out passage 96, with which small residual volumes and, in the flow-through channels, a high cooling efficiency are achieved.

Instead of one flow-through passage 92 having a cooler 100 and a check valve 106, a plurality of flow-through passages having coolers and check valves can be used, and/or the flow through a cooler can be blocked or permitted using a plurality of check valves.

Instead of the one flow-through passage 94, a plurality of flow-through passages can be formed between the flow-through chambers 80 and 82.

The movement of the flow-through piston 86 is, as evident from FIG. 4, characterized in particular by the following:

The time progression of the pushing-out or blowing-in of the compressed fresh charge out of the flow-through chamber 82 into the power chamber 36 (combustion chamber) essentially determines the progression of the combustion. Therefore, the pushing-out function is relatively steep. The pushing-out (blowing-in) begins preferably between approximately 10° to approximately 0° before the top dead point of the power piston 18 (hot piston) and ends preferably between approximately 30° and 40° after the top dead point of the power piston 18. In order to achieve this, the flow-through piston 86 remains in its top dead point and its bottom dead point over relatively long periods of time, so that distinct plateaus result.

The phase shift between the compression piston 16 and the power piston 18 is preferably selected such that the highest possible compensation of the second engine order in the engine results. Preferred values are 90° or 270° lag of the power piston 18 (hot piston). At a value of 90°, however, the time windows for the flow-through from the compressor side (cold side) to the power side (hot side) are very small, so that a lag of the power piston 18 of 270° is preferred. The excitations of the first order arising due to this arrangement can be compensated by appropriate compensating masses on the cam shafts, since the described engine preferably operates with two cam shafts rotating in opposite directions at the rotational speed of the crankshaft.

Since the upward movement of the flow-through piston 84 is coupled to the movement of the compression piston 16 for process-related reasons, and the pushing-out movement of the flow-through piston 86 is coupled to the power piston 18, the dwell phase (plateau length) in the movement of the flow-through piston 86 results from the selection of the phase shift between the movement of the power piston 18 and the movement of the compression piston 16.

In a simplified modification, only one flow-through chamber similar to the flow-through chamber 42 of the embodiment according to FIG. 1 can be used, and the flow-through passage out of the compression chamber 34 into the single flow-through chamber can be designed like the flow-through passage 92, i.e. with active cooling of the flowing-through fresh charge.

The coolers 100 and 110 can be integrated into a cooling system, with which other portions of the internal combustion engine are cooled, or can be flowed-through by a coolant which is cooled in a separate circulation of ambient air.

An internal combustion engine having two flow-through chambers disposed in series was described with the assistance of FIG. 2. There can also be more than two flow-through chambers disposed in series.

The maximum volume of the flow-through chamber 80 bordering the compression chamber 34 is for example between 5% and 15%, that is e.g. 10%, of the maximum volume of the compression chamber 34. Each additional flow-through chamber following a flow-through chamber has, for example, a maximum volume that is for example 30% to 50%, e.g. 40%, of the maximum volume of the preceding flow-through chamber.

The invention was described above with the example of an internal-combustion engine having a compression cylinder and a power cylinder. A plurality of compression cylinder/power cylinder units could respectively be provided, which for example are connected with a common crankshaft. It is also possible to associate a plurality of compression cylinders with one power cylinder.

### REFERENCE NUMBER LIST

10 Crankshaft
12 Piston rod
14 Piston rod
16 Compression piston
18 Power piston
20 Compression cylinder
22 Power cylinder
24 Cylinder liner
28 Cylinder housing
30 Cylinder head
32 End wall
33 Flow-through cylinder
34 Compression chamber
36 Power chamber
38 Fuel injection valve
40 Flow-through piston
42 Flow-through chamber
44 Fresh charge intake manifold
46 Fresh charge intake manifold
48 Exhaust manifold
50 Exhaust valve
52 Flow-through valve
53 Spring
54 Intake valve
56 Fresh charge cam
58 Exhaust cam
60 Intake cam
62 Flow-through cam
80 Flow-through chamber
82 Flow-through chamber
84 Flow-through piston
86 Flow-through piston
88 Flow-through cam
90 Flow-through cam
92 Flow-through passage
94 Flow-through passage
96 Push-out passage
98 Through-opening
100 Cooler
102 Heat exchanger channels
104 Valve seat
106 Check valve
108 Through-opening
110 Cooler
112 Heat exchanger channels
114 Valve seat
116 Check valve

1. A method for operating an internal combustion engine comprising:
a power cylinder having a power chamber delimited by a power piston, the power chamber having an intake valve and an exhaust valve,
a compression cylinder having a compression chamber delimited by a compression piston, the compression chamber having a fresh charge intake valve and a flow-through valve, and
at least one flow-through chamber delimited by a flow-through piston, which flow-through chamber is connected with the compression chamber when the flow-through valve is open and is connected with the power chamber when the intake valve is open,
the method comprising:
flowing-in fresh charge into the compression chamber while increasing the volume of the compression chamber,
compressing fresh charge located in the compression chamber while decreasing the volume of the compression chamber,
pushing-over the compressed fresh charge into the at least one flow-through chamber,
pushing-out the fresh charge located in the at least one flow-through chamber into the power chamber by decreasing the volume of the at least one flow-through chamber using the flow-through piston,
combusting the fresh charge located in the power chamber while increasing the volume of the power chamber and while converting thermal energy into mechanical output power and
discharging the combusted charge while decreasing the volume of the power chamber,
wherein the compressed fresh charge is cooled during the step of pushing-over the compressed fresh charge from the compression chamber into the at least one flow-through chamber.

2. The method according to claim 1, wherein:
the at least one flow-through chamber is one of a plurality of flow-through chambers, each delimited by a flow-through piston, that are arranged in series,
the compressed fresh charge is pushed over from the compression chamber into a first of the flow-through chambers,
the compressed fresh charge is pushed out of each respective flow-through chamber by decreasing the volume of the respective flow-through chamber using its flow-through piston, into the flow-through chamber downstream thereof, and is cooled while flowing from each flow-through chamber into the flow-through chamber downstream thereof, and
the compressed charge is pushed out of the last of the flow-through chambers into the power chamber.

3. The method according to claim 2, wherein fuel is added to the fresh charge upstream from the intake valve so that, when the intake valve is open, combustible mixture is pushed out into the power chamber, and is combusted in the power chamber.

4. An internal combustion engine comprising:
at least one power cylinder having a power chamber delimited by a power piston, the power chamber having an intake valve and an exhaust valve,
at least one compression cylinder having a compression chamber delimited by a compression piston, the compression chamber having a fresh charge intake valve, and
a flow-through apparatus having at least one flow-through chamber delimited by a flow-through piston, the at least one flow-through chamber being fluidly connected with the compression chamber via a flow-through passage, in which a flow-through valve is disposed, and the at least one flow-through chamber is directly or indirectly connected with the power chamber via a push-out passage, in which the intake valve is disposed,
wherein:
the pistons and the operation of the valves are configured to move in a coordinated manner such that fresh charge compressed in the compression chamber is pushed over by the compression piston into the flow-through chamber and is pushed out of the flow-through chamber by the flow-through piston into the power chamber, and
wherein the flow-through passage leads through a cooler.

5. The internal combustion engine according to claim 4, wherein:
the at least one flow-through chamber is one of a plurality of flow-through chambers disposed in series, each delimited by a flow-through piston;
each flow-through chamber is connected with another via a further flow-through passage leading through a further cooler, each further flow-through passage being closable by a further flow-through valve, and
the first flow-through chamber in the series is connected with the compression chamber, and the last flow-through chamber in the series is connected with the power chamber.

6. The internal combustion engine according to claim 5, wherein each flow-through passage is formed by heat exchanger channels that fluidly connect adjacent chambers, wherein each flow-through passage is disposed in a through opening, which penetrates through a wall bordering adjacent chambers.

7. The internal combustion engine according to claim 6, wherein the flow-through valves are formed as check valves, which respectively open downstream into the flow-through chambers that are disposed in series.

8. The internal combustion engine according to claim 7, wherein the compression chamber or at least one of the flow-through chambers has a minimum volume that is smaller than 15% of its maximum volume.

9. The internal combustion engine according to claim 8, wherein the maximum volume of the flow-through chamber bordering the compression chamber is smaller than that of the compression chamber, and the maximum volume of subsequent flow-through chamber disposed in series is smaller than that of the respective preceding flow-through chamber.

10. The internal combustion engine according to claim 9, wherein the compression piston and the power piston are connected with a crankshaft via piston rods, and the flow-through pistons are actuatable by cams, which are drivable by the crankshaft.

11. The internal combustion engine according to claim 5, wherein the flow-through valves are formed as check valves, which respectively open downstream into the flow-through chambers that are disposed in series.

12. The internal combustion engine according to claim 4, wherein the compression chamber and/or the at least one flow-through chamber has a minimum volume that is smaller than 5% of its maximum volume.

13. The internal combustion engine according to claim 4, wherein the compression chamber and/or the at least one flow-through chamber has a minimum volume that is smaller than 1% of its maximum volume.

14. The internal combustion engine according to claim 5, wherein the flow-through chamber bordering the compression chamber has a maximum volume that is smaller than the maximum volume of the compression chamber, and the maximum volume of each subsequent flow-through chamber is smaller than the maximum volume of the preceding, upstream flow-through chamber.

15. The internal combustion engine according to claim 4, wherein the cooler comprises heat exchanger channels fluidly connecting the compression chamber with the at least one flow-through chamber, wherein the flow-through passage is disposed in a through-opening that penetrates through a wall bordering the compression chamber and the at least one flow-through chamber.

16. An internal combustion engine comprising:
at least one power cylinder having a power chamber delimited by a power piston, the power chamber having an intake valve and an exhaust valve,
at least one compression cylinder having a compression chamber delimited by a compression piston, the compression chamber having a fresh charge intake valve,
at least a first flow-through chamber delimited by a first flow-through piston and being fluidly connected with the compression chamber via a first flow-through passage, and being directly or indirectly fluidly connected with the power chamber via a push-out passage,
a first flow-through valve disposed in the first flow-through passage, and
a first cooler arranged so as to cool compressed fresh charge flowing through the first flow-through passage,
wherein the intake valve is disposed in the push-out passage, and
the pistons and the valves are configured to move in a coordinated manner such that the compressed fresh charge is pushed over by the compression piston from the compression chamber into the first flow-through chamber and is ultimately pushed out into the power chamber.

17. The internal combustion engine according to claim 16, further comprising:
a second flow-through chamber fluidly connected with the first flow-through chamber via a second flow-through passage, the second flow-through chamber being delimited by a second flow-through piston,
a second flow-through valve disposed in the second flow-through passage, and
a second cooler arranged so as to cool compressed fresh charge flowing through the second flow-through passage.

18. The internal combustion engine according to claim 16, wherein the first flow-through chamber has a smaller maximum volume than the compression chamber, and the second flow-through chamber has a smaller maximum volume than the first flow-through chamber.

19. A method for operating an internal combustion engine comprising:
a power cylinder having a power chamber delimited by a power piston, the power chamber having an intake valve and an exhaust valve,
a compression cylinder having a compression chamber delimited by a compression piston, the compression chamber having a fresh charge intake valve and a flow-through valve, and
at least one flow-through chamber delimited by a flow-through piston and being fluidly connected with the compression chamber when the flow-through valve is open,
the method comprising:
flowing-in fresh charge into the compression chamber while increasing the volume of the compression chamber,
compressing the fresh charge located in the compression chamber while decreasing the volume of the compression chamber,
pushing-over the compressed fresh charge into the at least one flow-through chamber while simultaneously cooling the compressed fresh charge,
pushing the fresh charge out of the at least one flow-through chamber by decreasing the volume of the at least one flow-through chamber using the flow-through piston,
combusting the fresh charge in the power chamber while increasing the volume of the power chamber and while converting thermal energy into mechanical output power and
discharging combusted charge while decreasing the volume of the power chamber.

20. The method according to claim 19, wherein:
the internal combustion engine further comprises at least a second flow-through chamber delimited by a second flow-through piston, and
the method further comprises:
adding fuel to the fresh charge upstream of the intake valve so that, when the intake valve is open, a combustible mixture is pushed into the power chamber,
pushing the compressed fresh charge from the at least one flow-through chamber into the second flow-through chamber while simultaneously cooling the compressed fresh charge, and
pushing the compressed fresh charge from the second flow-through chamber into the power chamber.
